(19) United States
(12) Patent Application Publication
(10) Pub. No.: US 2009/0038760 A1
(43) Pub. Date: Feb. 12, 2009

(54) Glue distribution device of an embossing-lamination group

(76) Inventor: Giovanni Gambini, Pisa (IT)

Correspondence Address: HEDMAN & COSTIGAN P.C., 1185 AVENUE OF THE AMERICAS, NEW YORK, NY, 10036, US

(21) Appl. No.: 12/221,753

(22) Filed: Aug. 6, 2008

(30) Foreign Application Priority Data
Aug. 8, 2007 (IT) MI2007A 001654

(51) Int. Cl. B32B 37/12

(52) U.S. Cl. 156/578

(57) ABSTRACT

An improved glue supply device (10) of an embossing-lamination group (100) comprising an embossing roll (12), an embossing counter-roll (11), a glue distribution roll (14) and a glue transporting roll (15), wherein the embossing roll (12) is respectively coupled along two different generatrices with the embossing counter-roll (11) for embossing at least one paper ply (13) and with the distribution roll (14) for distributing the glue on said at least one embossed paper ply (13), and wherein the transporting roll (15) is respectively coupled along two different generatrices with the supply device (10) to collect the glue and with the distribution roll (14) for feeding the collected glue onto the distribution roll (14), wherein one container element (20, 21, 21′) of the glue is envisaged, comprising two side walls (21, 21′) seal coupled against a cylindrical surface portion of the transporting roll (15) defining a supply opening of the glue, wherein at least one of the two side walls (21, 21′) can be moved parellelly with respect to a rotation axis (16) of the transporting roll (15) to increase and/or reduce the width of the supply opening.

The present invention relates to an improved glue distribution device of an embossing-lamination group.

There are currently various different types of embossing-lamination groups for paper.

These groups generally comprise at least one embossing roll, at least one embossing counter-roll, at least one glue distribution roll and at least one transporting roll of the same glue.

The embossing roll is normally in contact on one side with an embossing counter-roll, for embossing at least one paper ply fed, and on the other side with the distribution roll for distributing glue on the same embossed paper ply.

The purpose of the transporting roll of these groups is to feed glue onto the distribution roll and for this purpose, its outer surface is in turn coupled on one side with a glue tank and on the other with the distribution roll.

Thanks to this coupling of rolls, in which the transporting roll is generally called “netted” and the distribution roll “cliché”, the glue is removed from a tank and positioned on at least one embossed paper ply passing over the same cliché.

The embossing-lamination groups described above however have various drawbacks.

These disadvantageous aspects occur when there is a change in the width of the paper which is fed to the group.

If a particular paper with a width which is less than the development of the cliché roll, is fed, in fact, at present the latter unfortunately distributes glue not only on the paper but also on the surface of the embossing roll against which it is acting and which is not covered by the paper.

As the cliché roll has a greater width development than the paper which is being fed, it acts in some of its portions directly against the embossing roll depositing glue thereon.

In order to avoid this drawback, which disadvantageously leads not only to a waste of glue but also to the breakage of the paper during the embossing and in general to the malfunctioning of the group as a whole, the cliché roll is substituted each time with a roll having the same width development of the paper which is being fed to the same group.

As can be deduced, this procedure is extremely disadvantageous from both an economical and productive point of view as it requires high costs for the cliché rolls to be substituted each time and also prolonged stoppage times of the group during said substitution of the rolls.

An objective of the present invention is to provide a device capable of solving the above drawbacks of the known art in an extremely simple, economical and particularly functional way.

A further objective is to provide an improved glue distribution device of an embossing-lamination group which reduces the waste of glue with any width of paper fed.

Another objective is to avail of an improved glue distribution device of an embossing-lamination group capable of adapting itself to the various widths of the paper to be glued without having to resort to the substitution of any roll of the group without any waste of glue.

These objectives according to the present invention are achieved by providing an improved glue distribution device of an embossing-lamination group as specified in claim 1.

Further characteristics of the invention are indicated in the subsequent claims.

The characteristics and advantages of an improved glue distribution device of an embossing-lamination group according to the present invention will appear more evident from the following illustrative and non-limiting description, referring to the enclosed schematic drawings, in which:

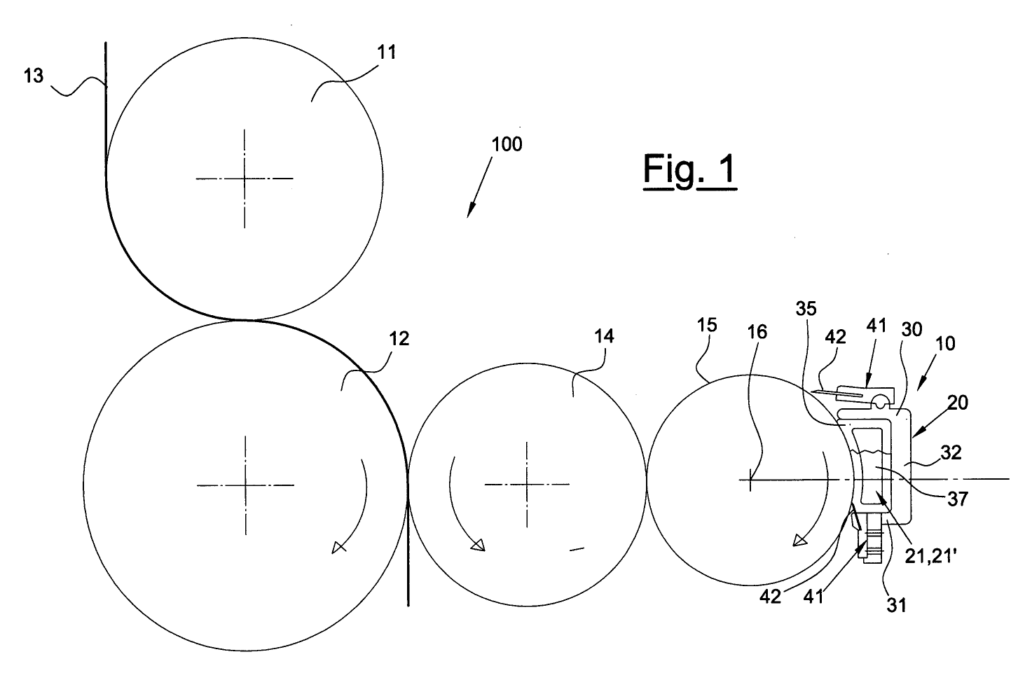

FIG. 1 is a raised schematic and partially cross-sectional side view of an improved glue distribution device of an embossing-lamination group according to the present invention;

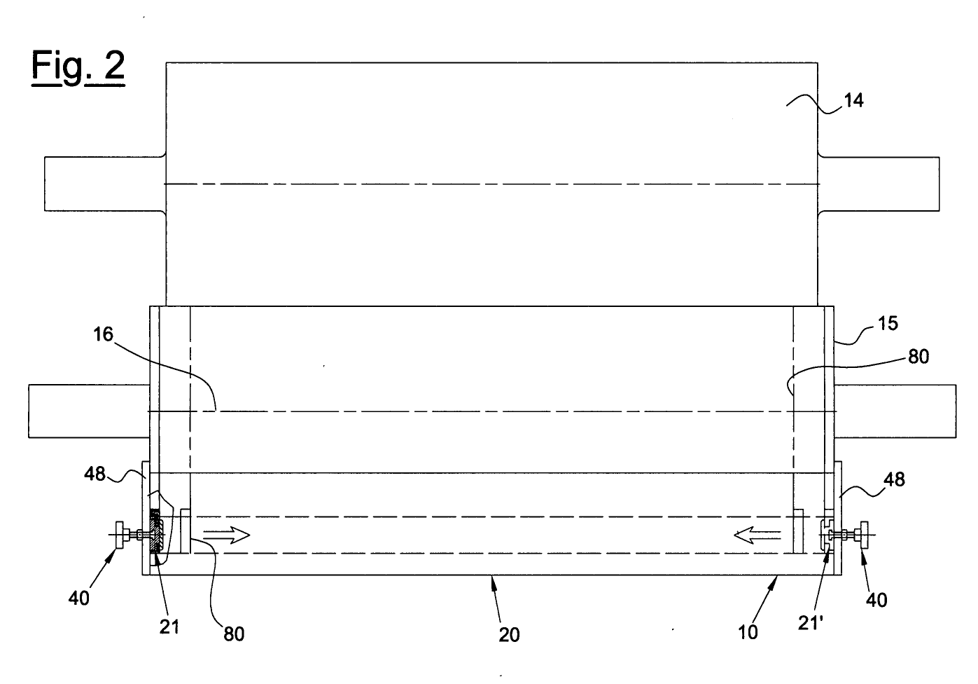

FIG. 2 is a view from above of some of the elements of the partial cross-section of FIG. 1;

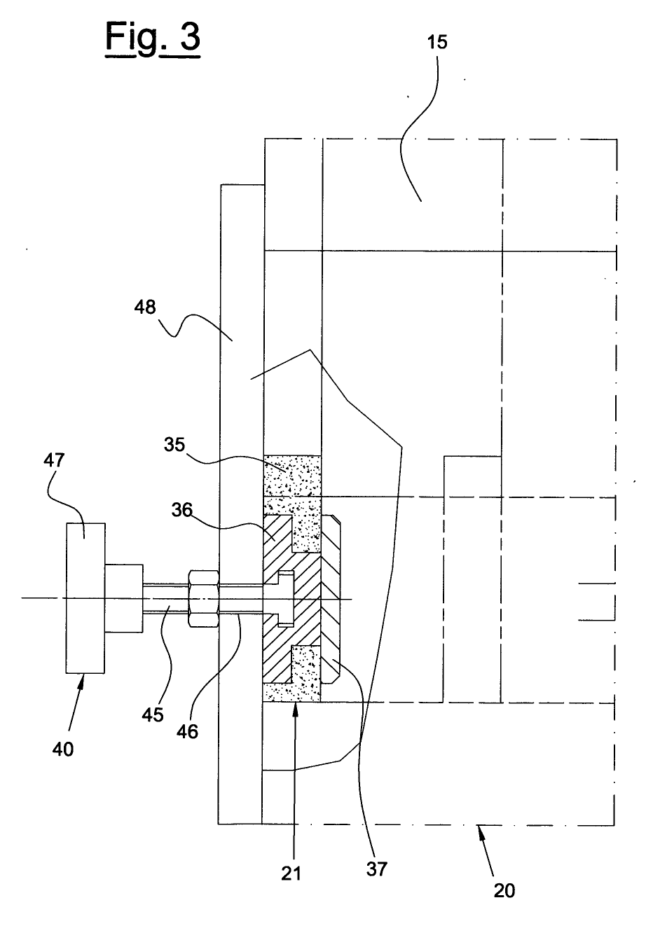

FIG. 3 is an enlarged detail of the partial cross-sectional portion of FIG. 2; and

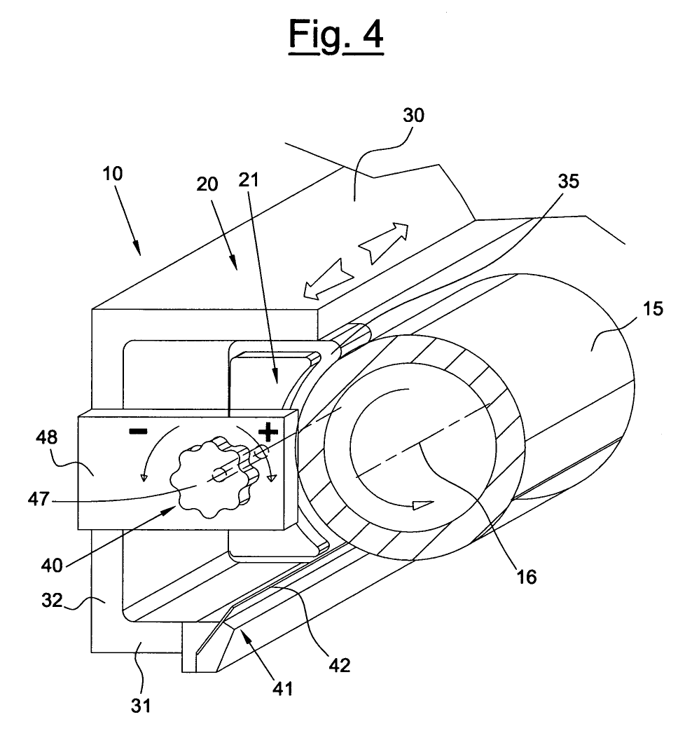

FIG. 4 is a perspective view of the improved glue distribution device of an embossing-lamination group according to the present invention.

With reference to the figures, these show an improved glue distribution device 10 of an embossing-lamination group according to the present invention.

The term glue generally refers to a gluing substance preferably with a fluid behaviour.

As can be seen in FIG. 1, the improved device 10 for supplying glue, object of the present invention, can be advantageously applied to a known embossing-lamination group 100.

According to the embodiment shown in the above FIG. 1, this embossing-lamination group 100 comprises an embossing roll 12, an embossing counter-roll 11, a glue distribution roll 14 and a transporting roll 15 of the same glue.

In particular, the embossing roll 12 is respectively coupled along two different generatrices with the embossing counter-roll 11 for embossing at least one paper ply 13 and with the distribution roll 14 for distributing the glue on at least one embossed paper ply 13.

The transporting roll 15 is in turn respectively coupled along two different generatrices with the supply device 10 for removing the glue and with the distribution roll 14 for feeding the removed glue onto the distribution roll 14.

According to the invention, the improved glue supply device comprises a glue container element 20, 21, 21′ having two side walls 21, 21′ seal coupled against a cylindrical surface portion of the transporting roll 15 defining a supply opening of said glue through which the glue is supplied on the transporting roll 15.

In particular, according to the invention, at least one of the two side walls 21, 21′ is parellelly moveable with respect to the rotation axis 16 of the transporting roll 15 and in this way allows the width of the glue supply opening to be increased and/or reduced thus modifying, as desired, the portion of the development of the transporting roll 15 wet by the glue and consequently indirectly modifying, as desired, the portion of the development of the distribution roll, or cliché roll, wet by the glue.

In this way, it is therefore possible to proceed with supplying the correct quantity of glue on an adequate surface of the rolls of the embossing-lamination group 100 advantageously corresponding to the width of at least one ply 13 to be glued, fed to the group itself.

Consequently, according to the invention, possible accidental distributions of glue on the surfaces of the rolls of the embossing-lamination group 100 not covered by at least one ply 13 are prevented, as already mentioned in the case of a cliché roll with a greater development than the width of the paper 13 to be glued, by increasing and/or reducing the width of the glue supply opening without having to resort, as is currently required, to the substitution of some of the rolls depending on the width of at least one ply 13 to be glued.

FIG. 2 shows with a dashed line 80 a possible configuration of use in which the glue is not supplied over the whole development of the roll 15 but only on a portion which is advantageously equivalent to the width of the at least one ply 13 to be glued.

The direction of the movement of the at least one moveable side wall 21, 21′ is indicated with arrows parallel to the development of the transporting roll 15 in FIGS. 2 and 4.

The supply device 10 according to the present invention also comprises guiding means and regulation means 40 of the position of at least one moveable side wall 21, 21′ so as to allow and regulate the increase and/or reduction in the width of the glue supply opening.

According to a preferred embodiment visible in FIGS. 1 and 4, the container element 20, 21, 21′ comprises a “C”-shaped body 20, suitable for containing the glue, which is positioned laterally substantially along the whole development of the transporting roll 15, as can be seen in FIG. 2 which schematically shows the whole transporting roll 15.

Furthermore, the “C”-shaped body 20 comprises two peripheral portions 30, 31 substantially parallel to each other which extend towards the transporting roll 15 and a central portion 32 substantially orthogonal to the two peripheral portions 30, 31.

As can be seen in FIGS. 1 and 4, the two peripheral portions 30, 31 extend as far as the proximity of the side surface portion of the transporting roll 15.

In order to avoid a possible waste of glue, there is also the presence of at least one scraping element 41 externally connected to the container element 20, 21, 21′ suitable for maintaining a correct thickness of the layer of glue on the transporting roll 15.

As can be seen in FIGS. 1 and 4, the at least one scraping element 41 is equipped for this purpose with a blade element 42 which can be coupled with a surface portion of the transporting roll 15 upstream and/or downstream of the container element of the glue 20, 21, 21′.

According to the present invention, the at least one moveable side wall 21, 21′ comprises, as can be seen in FIG. 3, a perimetric resting portion 35 with the transporting roll 15 and with the “C”-shaped body 20.

In particular, said perimetric portion 35 acts as a seal for withholding the glue inside the box element 20, 21, 21′ without allowing side leakages and is therefore preferably made of rubber to provide an optimum buffer, becoming locally deformed, with the transporting roll 15.

As can be seen in FIG. 3, the at least one moveable side wall 21, 21′ can also comprise an internal supporting core 36 for the perimetric portion 35 and, according to a preferred embodiment, also at least one sealing flange 37 of the perimetric portion 35 on the internal core itself 36.

In FIG. 3, this flange 37 is positioned laterally with respect to the at least one moveable side wall 21, 21′.

As already mentioned, the supply device 10 comprises a container element 20, 21, 21′ having at least one moveable side wall 21, 21′ for varying the opening of said container element 20, 21, 21′ from which the glue is discharged onto the roll 15, according to requirements and the width of the paper to be glued.

For the moving of the at least one side wall 21, 21′, the supply device 10 comprises relative regulation means 40 of the position of the at least one side wall 21, 21′ with respect to the container element 20, 21, 21′ which are preferably a screw-lead screw mechanism 45, 46.

As can be seen in FIG. 3, the lead screw 46 is preferably a threaded blind hole situated inside the at least one moveable side wall 21, 21′ towards the outside of the container element 20, 21, 21′ and the screw 45 comprises a first end firmly housed in the at least one moveable side wall 21, 21′ and a second free end having a manual rotation knob 47 of the same screw 45.

In particular, the manual rotation knob 47 of the screw 45 is preferably externally constrained to the container element 20, 21, 21′ by means of a supporting group 48 laterally connected to the central portion 32 of the “C”-shaped body 20, as can be seen in FIG. 4.

Finally, the presence is envisaged of guiding means of the at least one moveable side wall 21, 21′, which, in the examples shown, are the internal walls of the “C”-shaped body 20.

The functioning of the device, object of the invention, can be easily understood.

According to the invention, the improved device for supplying glue comprises a container element 20, 21, 21′ of the same glue having two side walls 21, 21′ seal coupled against a cylindrical surface portion of the transporting roll 15 defining, with the remaining components of the container element 20, 21, 21′, a supply opening through which the glue is supplied to the transporting roll 15.

In particular, according to the invention, at least one of the two side walls 21, 21′ is parellelly moveable with respect to the rotation axis 16 of the transporting roll 15 and in this way allows the width of the glue supply opening to be increased and/or reduced thus modifying, as desired, the length of the development of the transporting roll 15 wet by the glue.

In this way, it is therefore possible to supply the correct quantity of glue over an adequate surface of the rolls of the embossing-lamination group 100 corresponding to the width of the at least one ply 13 to be glued.

According to the invention, any possible accidental glue distribution on the surfaces of the rolls of the embossing-lamination group 100 not covered by at least one ply 13 to be glued, is therefore avoided, by increasing and/or reducing the width of the glue supply opening without having to resort, as is currently required, to the substitution of the rolls of the embossing-lamination group 100 depending on the width of at least one ply 13 to be glued.

It can therefore be seen that an improved glue distribution device of an embossing-lamination group according to the present invention achieves the objectives listed above.

The improved glue distribution device of an embossing-lamination group according to the present invention thus conceived can undergo numerous modifications and variants, all included in the same inventive concept; furthermore, all the details can be substituted by technically equivalent elements. In practice, the materials used, as also the dimensions, can vary according to technical requirements.

1. An improved glue supply device (10) of an embossing-lamination group (100) comprising an embossing roll (12), an embossing counter-roll (11), a distribution roll (14) of said glue, and a transporting roll (15) of said glue, wherein said embossing roll (12) is respectively coupled along two different generatrices with said embossing counter-roll (11) for embossing at least one paper ply (13) and with said distribution roll (14) for distributing said glue on said at least one embossed paper ply (13), and wherein said transporting roll (15) is respectively coupled along two different generatrices with said supply device (10) to collect said glue and with said distribution roll (14) for feeding said collected glue onto said distribution roll (14), characterized in that it comprises a container element (20, 21, 21′) of said glue, comprising two side walls (21, 21′) seal coupled against a cylindrical surface portion of the transporting roll (15) defining a supply opening of said glue, wherein at least one of said two side walls (21, 21′) can be moved parellelly with respect to a rotation axis (16) of said transporting roll (15) to increase and/or reduce the width of said supply opening.

2. The device (10) according to claim 1, characterized in that it comprises guiding means and regulation means (40) of the position of said at least one moveable side wall (21, 21′).

3. The device (10) according to claim 1, characterized in that said container element (20, 21, 21′) also comprises a “C”-shaped body (20) positioned laterally substantially along the whole development of said transporting roll (15).

4. The device (10) according to claim 3, characterized in that said “C”-shaped body (20) comprises two peripheral portions (30, 31) substantially parallel to each other, which extend towards said transporting roll (15) and a central portion (32) substantially orthogonal to said two peripheral portions (30, 31), wherein said two peripheral portions (30, 31) extend to the proximity of said side surface portion of said transporting roll (15).

5. The device (10) according to claim 1, characterized in that it also comprises at least one scraping element (41) externally connected to said container element (20, 21, 21′).

6. The device (10) according to claim 5, characterized in that said at least one scraping element (41) is equipped with a blade element (42) coupled with a surface portion of said transporting roll (15) upstream and/or downstream of said container element of said glue (20, 21, 21′).

7. The device (10) according to claim 1, characterized in that said at least one moveable side wall (21, 21′) comprises a perimetric resting portion (35) with said transporting roll (15) and with said “C”-shaped body (20).

8. The device (10) according to claim 7, characterized in that said at least one moveable side wall (21, 21′) also comprises an internal supporting core (36) for said perimetric portion (35).

9. The device (10) according to claim 8, characterized in that said at least one moveable side wall (21, 21′) also comprises at least one sealing flange (37) of said perimetric portion (35) on said internal core (36) positioned laterally with respect to said at least one moveable side wall (21, 21′).

10. The device (10) according to claim 7, characterized in that said peripheral portion (35) is made of rubber.

11. The device (10) according to claim 2, characterized in that said regulation means (40) are a screw-lead screw mechanism (45, 46).

12. The device (10) according to claim 11, characterized in that said lead screw (46) is a threaded blind hole situated inside said at least one moveable side wall (21, 21′) towards the outside of said container element (20, 21, 21′) and said screw (45) comprises a first end firmly housed in said at least one moveable side wall (21, 21′) and a second free end having a manual rotation knob (47) of said screw (45).

13. The device (10) according to claim 12, characterized in that said manual rotation knob (47) of said screw (45) is externally constrained to said container element (20, 21, 21′) by means of a supporting group (48) laterally connected to said central portion (32) of said “C”-shaped body (20).

14. The device (10) according to claim 3, characterized in that said guiding means of said at least one moveable side wall (21, 21′) are the internal walls of said “C”-shaped body (20).
